(19) United States
(12) Patent Application Publication
(10) Pub. No.: US 2006/0291726 A1
(43) Pub. Date: Dec. 28, 2006

(54) Object pattern detection method and its apparatus

(75) Inventors: Hidenori Takeshima, Kanagawa (JP); Koichi Masukura, Tokyo (JP); Takashi Ida, Kanagawa (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/417,135

(22) Filed: May 4, 2006

(30) Foreign Application Priority Data
Jun. 27, 2005 (JP) 2005-186998

(51) Int. Cl. G06K 9/62

(52) U.S. Cl. 382/209

(57) ABSTRACT

A method to detect a given pattern in an image, as for obtaining, by a computer, transformation parameters that facilitate transformation of a template as to be overlapped with the object, comprising: inputting the template having contour points and region distinguishing information for each points; inputting contour candidate points and region distinguishing information for each points; transforming a position or a shape of the template by using each of transformation parameter set candidates; obtaining an evaluation value, or similarity of a distribution of the object and background regions, on each overlapping pair between one of the contour candidate points in the image and one of the contour points of the template; obtaining sum of the evaluation values only for those not smaller than a threshold evaluation value, for the each of the transformation parameter set candidates; and outputting a transformation parameter set having largest sum of the evaluation values.

### CROSS-REFERENCE TO RELATED APPLICATIONS

This application is based upon and claims the benefit of priority from the prior Japanese Patent Application No. 2005-186998, filed on Jun. 27, 2005; the entire contents of which are incorporated herein by reference.

### TECHNICAL FIELD

The invention relates to a method and an apparatus to detect an object pattern in an image when the pattern (for example, a shape pattern of an average person) to be detected is given on beforehand.

### BACKGROUND OF THE INVENTION

As a method suitable for detection of an object, a generalized Hough transform disclosed by D. H. Ballard (“Generalizing the Hough Transform to Detect Arbitrary shapes”, Pattern Recognition Vol. 13, No. 2, pp. 111-122, 1981) is widely used in which a predetermined template “T” is detected from an image “S”.

In this method, first, a template is inputted (S201 of FIG. 2), and a pixel on which an edge exists is obtained in an image “S” and is inputted (S202).

Next, with respect to each contour candidate point in the image “S”, voting is performed for all of transformation parameters (for example, a position, an enlargement ratio, a rotation angle) which have the possibility of transforming the contour candidate point as to overlap with the contour point on the template “T” (S203 to S205).

Finally, a parameter forming the peak in a vote space is outputted as a detected transformation parameter (S206).

By this, even if an object pattern is moved or deformed, the pattern of the object in the image can be detected.

In the above method, even for a pattern other than the object pattern, a peak can occur in the vote space and erroneous detection can be performed.

For example, in a rectangular template, in addition to a correct peak representing an occasion in which both long sides of the template overlap with the edge, there occur two peaks representing occasions in each of which only one side of the template overlaps with the edge, and the erroneous detection is performed.

It is accordingly intended to provide an object pattern detection method and its apparatus, in which occasions of detection of non-object patterns are decreased as to achieve a high detection rate.

### BRIEF SUMMARY OF THE INVENTION

According to embodiments of the present invention, in order to detect an object pattern in an image, there is adopted a method for searching or obtaining, by a computer, transformation parameters that facilitate transformation of a template in a manner that such transformed template overlap with the object pattern in the image; the method comprising: inputting a template having (1) contour points on a contour line of a pattern to be detected and (2) region distinguishing information to distinguish between an object region and a background region at each of the contour points; inputting (1) contour candidate points on a contour candidate line of an object in the image and (2) region distinguishing information to distinguish between an object region and a background region for each of the contour candidate points; transforming a position or a shape of the template by using each of transformation parameter set candidates; obtaining an evaluation value on each overlapping pair between one of the contour candidate points in the image and one of the contour points of the template, which overlap with each other after the transformation using the each of the transformation parameter set candidates, the evaluation value being similarity of a distribution of the object and background regions between that based on the region distinguishing information of the template and that based on the region distinguishing information of the image; obtaining sum of the evaluation values only for those not smaller than a threshold evaluation value, for the each of the transformation parameter set candidates; and outputting a transformation parameter set having largest sum of the evaluation values among the transformation parameter set candidates.

According to embodiments of the present invention, occasions of detection of non-object patterns are decreased as to achieve a high detection rate.

### BRIEF DESCRIPTION OF THE DRAWINGS

FIG. 1 is a flowchart for a pattern detection method of a first embodiment of the invention.

FIG. 2 is a flowchart for a conventional pattern detection method.

FIG. 3 is an explanatory view of a template.

FIG. 4 is an explanatory view of an object in an image which is subjected to pattern detection processing.

FIG. 5 is an explanatory view showing a manner of voting in the conventional pattern detection method.

FIG. 6 is a graph showing a voting result of the conventional pattern detection method.

FIG. 7 is an explanatory view showing a manner of voting of the first embodiment.

FIG. 8 is a graph showing a voting result of the first embodiment.

FIG. 9 is an explanatory view of a second embodiment.

FIG. 10 is block diagram of a pattern detection apparatus of the first embodiment.

FIG. 11 is an explanatory view of a binary bitmap.

FIG. 12 is an explanatory view of an occasion where voting is performed and an occasion where voting is omitted.

FIG. 13 is an explanatory view of a normal vector of an object.

FIG. 14 is a flowchart of a pattern detection method of the second embodiment.

FIG. 15 is a flowchart of a pattern detection method of a third embodiment.

FIG. 16 is a flowchart of a pattern detection method of a seventh embodiment.

FIG. 17 is a first explanatory view of a centripetal vector.

FIG. 18 is a second explanatory view of a centripetal vector.

FIG. 19 is a third explanatory view of a centripetal vector.

### DETAILED DESCRIPTION OF THE INVENTION

Hereinafter, a pattern detection method of an embodiment of the present invention and a pattern detection apparatus to realize that will be described.

[Outline]

First, the outline of a first embodiment will be described.

The generalized Hough transform is modified so that voting is performed only if information in respect of the inside and outside of a pattern to be detected coincides with information in respect of the inside and outside of a vicinity of an edge of an object image. Specifically, modification is made as follows.

A template “T” is a binary bitmap having two levels of values respectively for an object and a non-object, and a pixel across which the value is changed is taken as a contour of the template “T”.

When an edge pixel of an image “S” is to be obtained, a binary bitmap of an object and a non-object, which is obtained by using, for example, a background difference method or an inter-frame difference method, is inputted, and a pixel across which the value is changed is taken as the edge pixel of the image “S”.

As for voting for the edge pixel of the image “S”, voting is performed only in the case where the bitmap value distribution in the vicinity of the edge pixel of the image “S” coincides with that of the template “T”.

Next, the outline of a second embodiment will be described.

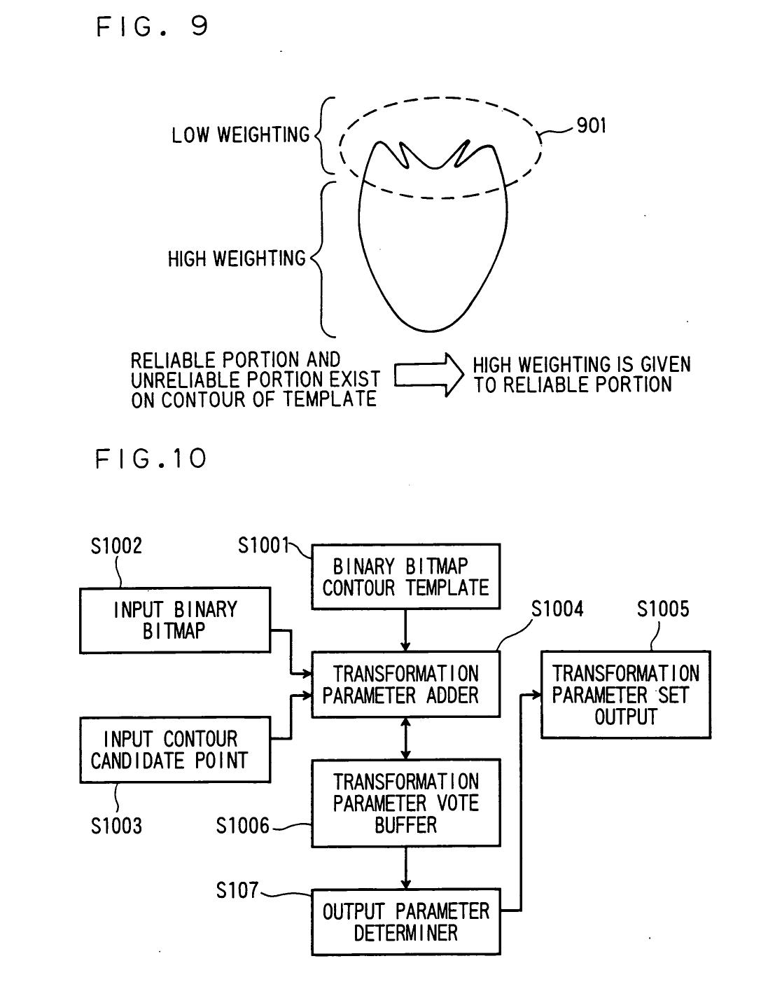

A template may have an indistinct portion in its contour, for example, when the template has a complicated contour as indicated by 901 of FIG. 9. Then, erroneous detection is likely to occur in the first embodiment, even if an edge judgment or an inside/outside information judgment is made at the indistinct portion.

In view of this, in the second embodiment, a weighting value is assigned to each contour point in the template. And at each time of the voting, the weighting value instead of 1 is added in the vote.

Incidentally, the “contour point” means a point on a contour line of a pattern to be detected, in a template. The “contour candidate point” means a point on a line predicted to be a contour line of an object, in an image from which the pattern is detected.

### First Embodiment

(1) Construction of Pattern Detection Apparatus

In this embodiment, a pattern detection apparatus shown in a block diagram of FIG. 10 is used. The pattern detection apparatus includes a transformation parameter adder 1004, a transformation parameter vote buffer 1006, and an output parameter determiner 1007.

The transformation parameter adder 1004 receives, as inputs, a binary bitmap 1002 of an object region and a non-object region and a contour candidate point 1003, and collates them against a template 1001 of a previously registered binary bitmap to detect an object pattern. The output parameter determiner 1007 outputs a transformation parameter.

(2) Pattern Detection Method by Introduction of Two-Level or Binary Bitmap

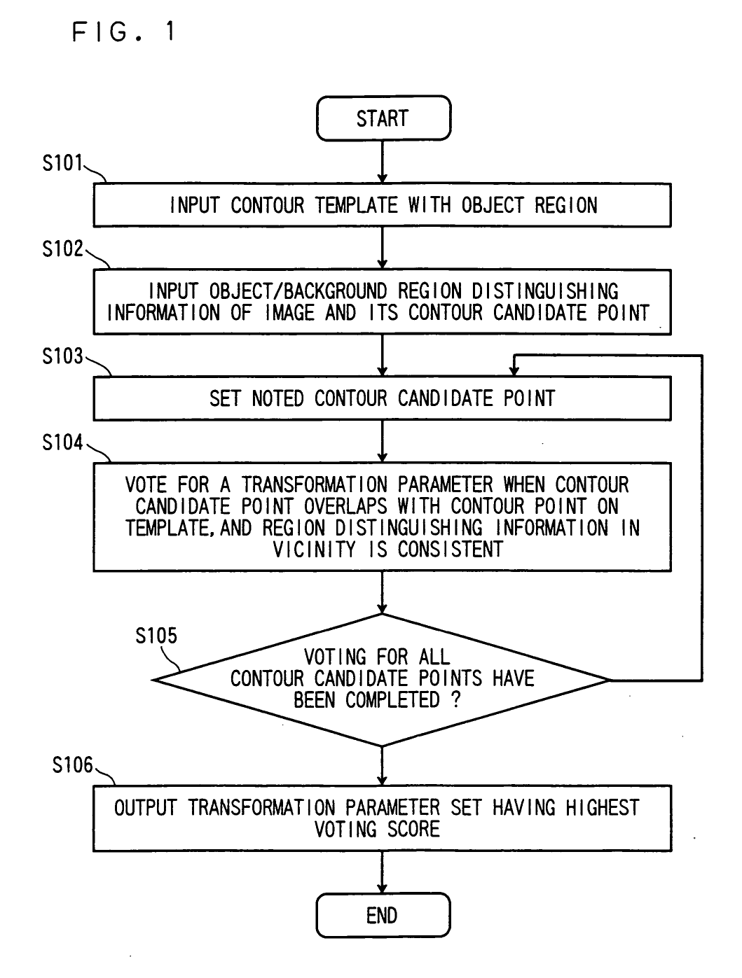

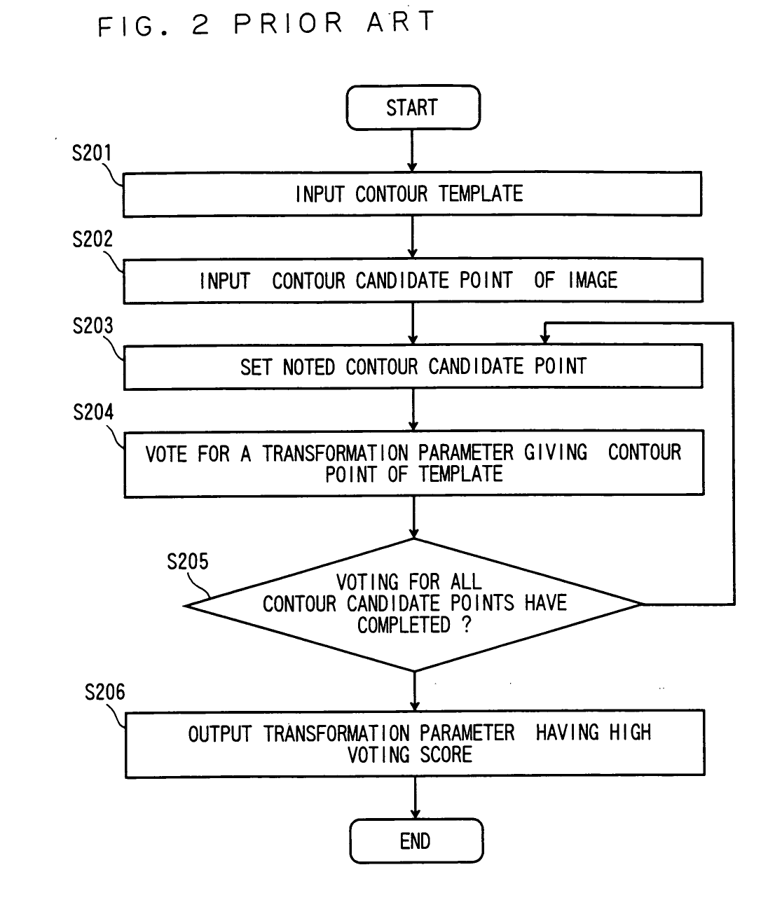

The embodiment of a pattern detection method using a binary bitmap of an object region and a non-object region will be described with reference to a flowchart of FIG. 1.

The transformation parameters may be; for example, (n+1) values to indicate an n-dimensional translation and an enlargement ratio; four values to indicate a two-dimensional translation, an enlargement ratio and a rotation; or 3n values to indicate an n-dimensional affine transformation.

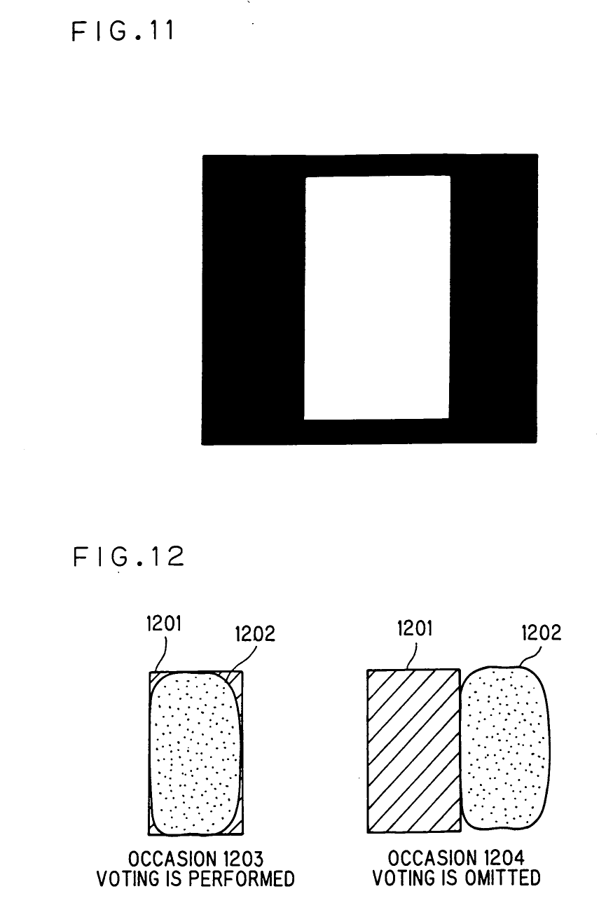

At S101, before detection is performed, first, a pattern to be detected is inputted and registered as the template 1001 of the binary bitmap. As to register the pattern, as shown in FIG. 11, contour points each having inside/outside information are inputted; for example, inputted is a binary bitmap to indicate that a white region having a value of 1 represents the inside of an object, and a black region having a value of 0 represents the outside of the object. Hereinafter, the binary bitmap is called a “binary mask”. In the binary mask, the boundary between the region (white region) having the value of 1 and the region (black region) having the value of 0 represents the contour line. The contour point of the detection pattern means, for example, a pixel on this boundary.

At S102, inputted are; an image from which the pattern is to be detected, and object/background region distinguishing information; and each object/background contour candidate point. In other words, inputted are the binary bitmap 1002 and the contour candidate points 1003 of FIG. 10. Here, as the object/background region distinguishing information, similarly to the above, a binary mask is used. As the contour candidate points of the image, similarly to the above, the boundary of the binary mask may be used; or, in otherwise, a pixel at which an output value of an edge detection filter such as a Sobel filter is out of a predetermined range may be taken as the boundary point or the contour candidate point.

At steps of S103 to S105, for a space of the transformation parameters as a candidate, voting is performed each time the template indicating the contour point is detected. Before the voting, a histogram to record a frequency value in respect of a possible set of transformation parameters, or a transformation parameter set candidate, is initialized. That is, all element numbers on the transformation parameter vote buffer 1006 are set to 0.

With respect to each of noted contour candidate points that is set at S103, the transformation parameter adder 1004 is used to perform the vote processing at S104. The vote processing at S104 gives a high vote number, or voting score, when contour point of the template and contour candidate point of the object overlap with each other and the inside/outside relations at the contour and the contour candidate points are equal to each other. For example, FIG. 12, in which reference numeral 1201 denotes a template and 1202 denotes an object in the image, indicates that high voting score is obtained for an occasion 1203 shown at left-hand side, and that voting is omitted for an occasion 1204 shown at right-hand side.

In order to realize this, at S104, voting to give some evaluation value is made for example only when followings (1)-(2) are satisfied: (1) with respect to each contour candidate point of the image, the contour candidate point of the image overlaps with a contour point on the template; and (2) in respect of such overlapping point or pixel (that is, overlapping pair between one of the contour candidate points and one of the contour points), the binary bitmaps in the vicinities of the contour candidate point of the image and the contour point have a similarity with each other same with or larger than a predetermined threshold value. In other words, obtained firstly is the similarity of a distribution of an object region and a background region between that in a predetermined region including the contour candidate point in the image and that in a predetermined region including the contour point. And, only when the similarity is same with or larger than the predetermined threshold value, the evaluation value is given. Then, sum of the evaluation values or the similarity values is obtained for each transformation parameter set candidate.

At S105, the vote processing of S104 is repeated until all contour candidate points are processed. Increase of an extent of overlapping between the contour candidate points in the image with the contour points of the template, or increase of number of the overlapping pairs between the contour candidate points in the image and the contour points in the template will increase the sum of the evaluation values as to increase the number of votes or voting score.

At S106, after completing of the voting processing for all contour candidate points, processing as following is performed; in the aforementioned histogram, a transformation parameter set candidate, or a set of transformation parameters as a candidate, for the peak (local maximum value) whose frequency value or the voting score is same with or larger than a predetermined threshold voting score is determined by the output parameter determiner 1007. Then, such determined one is outputted as an optimum set of transformation parameters or “transformation parameter set output” 1005.

The aforementioned histogram represents frequencies in a vote space, which is, for example, three dimensional as consisting of dimensions of a horizontal position, a vertical position and an enlargement ratio, or four dimensional as consisting of these three dimensions as well as a rotation ratio.

The peak is determined in a following manner; searching for a peak is made for a predetermined range around a peak candidate, in other words, frequency value is checked for a predetermined range around a certain transformation parameter; and when the peak candidate is confirmed to have a largest frequency or similarity in the predetermined range, the peak candidate is taken as the peak. The predetermined range for the searching may be, for example, a range where the Euclidean distance of the transformation does not exceed a predetermined value, around that of the peak candidate.

By the above method, the pattern is detected. When to prevent many peaks from being detected in a narrow range by noise or the like, some less significant peak may be deleted; for example, when one of the peaks is identified as having the maximum frequency value, another peaks (each of which is a local maximum but is not the maximum) in the vicinity of the one of peaks may be deleted.

(3) Modification; the Contour Point as a Line Segment

In the above embodiment, the description has been made under the assumption that the contour point in the detection pattern is the pixel. Nevertheless, the detection pattern may be expressed as a sectional line segment as in a method disclosed by Watanabe and Ishitobashi (“Acceleration of Generalized Hough Transforms by Polygonal Approximation and Detection of Arbitrary Shapes” The Institute of Electronics, Information and Communication Engineers Transactions, D-II, Vol. J74, No. 8, pp. 995-1003, 1991).

Besides, a template format may be changed or modified to decrease the wasteful number of votes as in an R-table disclosed by D. H. Ballard (in the article mentioned in the “BACKGROUND OF THE INVENTION”), or as in an extended C-table disclosed by Kimura and Watanabe (“Fast Generalized Hough Transform that Improves its Robustness of Shape Detection” The Institute of Electronics, Information and Communication Engineers Transactions, D-II. Vol. J83, No. 5, pp. 1256-1265, 2000).

(4) Inside/Outside Judgment Using Centripetal Vector

The inside/outside judgment in this embodiment may be made as follows, for example; a vector directed toward an object (hereinafter referred to as a “centripetal vector”) is prepared for each contour point of a template and each contour candidate point of an image; and a judgment is made based on an angle formed by the centripetal vectors of the contour point and the contour candidate point.

(4-1) Normal Vector as the Centripetal Vector

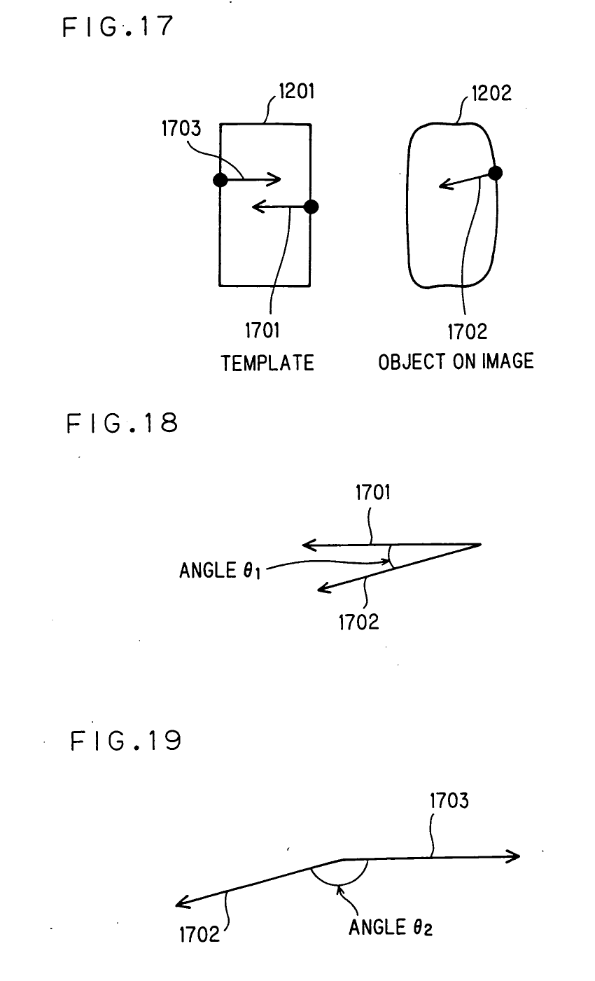

Examples of the centripetal vector are denoted by 1701, 1702, and 1703 in FIG. 17. Many ways of obtaining this vector are conceivable, and some examples thereof will be described next.

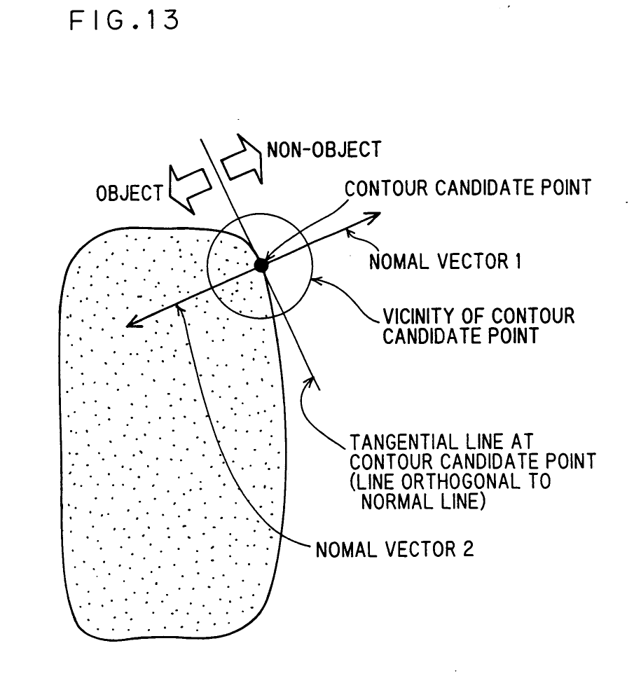

FIG. 13 shows an example in which a normal vector 1 directed toward an object and a normal vector 2 directed toward a non-object are obtained, and then, the normal vector 2 directed toward an object is selected.

When the direction of a line segment constituting a contour candidate point is already known, the two normal vectors 1 and 2 are obtained as the vectors vertical to the direction of the line segment. When the contour candidate point is a pixel with no known direction, the normal vectors are obtainable by following manner, for example. A predetermined number of contour candidate points, five contour candidate points for example, which are close to a noted contour point in Euclidean distance are picked up; and when an expression of a straight line obtained by applying the least squares method to those points is used as the direction of a tangential line or local direction of the contour candidate line, as to obtain the normal vectors 1 and 2.

When the vicinity of a pixel, or middle point of a line segment, constituting the contour candidate points taken as shown in FIG. 13, there are formed two semicircles divided by a tangential line, which is a straight line determined by the contour candidate point and a direction vector.

In order to determine the centripetal vector from the two normal vectors; for example, the number of pixels of an object region in the semicircular on each side of the normal vectors is counted, and one associated with larger number of pixels is selected.

(4-2) Other Vector as the Centripetal Vector

The centripetal vector other than the normal vector may be used.

For example, the centroid of all pixels constituting an object region is obtained; and a vector (which may be normalized to a predetermined length such as a length of 1) directed toward the centroid from a contour candidate point (in the case of a line segment, a middle point of two apexes constituting the line segment, for example) may be used as the centripetal vector.

(4-3) Inside/Outside (Coincidence) Judgment

It is determined whether each of the centripetal vectors for the contour candidate point is directed to inside of the object or to outside of the object, when the centripetal vector has been obtained for each contour candidate point by these methods. The judgment may be made based on whether an angle formed between the centripetal vector for the contour candidate point and a centripetal vector for a corresponding contour point on the template is within a predetermined range.

For example, with respect to the centripetal vector 1702 for the object on the image and the centripetal vector 1701 of the template, first, as shown in FIG. 18, an angle θ1 formed by the centripetal vectors 1701 and 1702 is obtained. Voting is performed only in the case where θ1 is in a predetermined range (for example, −30 degrees≦θ1≦30 degrees). When the angle between the centripetal vectors is out of this range as indicated by θ2 of FIG. 19, voting is omitted. In this example, the outside of the range means a reverse direction.

(5) Generation Method of Two-Level or Binary Bitmap

A binary bitmap to represent contour candidate points of an image may be obtained as follows: for example, binarization is performed according to whether each value obtained by edge detection exceeds a predetermined threshold; or according to whether an absolute value of each difference value obtained by a background difference method or an inter-frame difference method (hereinafter referred to as difference methods) exceeds a predetermined threshold.

The generation method of the binary bitmap other than the above also may be used.

(6) Generation Method of Three-Level or Ternary Bitmap

According to a generation method, a three-level bitmap, not a binary bitmap, can be obtained.

(6-1) Use of Foreground, Background, and Indistinct Regions

For example, the difference method is used by setting two values of “Th1” and “Th2” as thresholds as to obtain a three-level bitmap as follows. A region having absolute values of difference values same with or less than Th1 is decided as the background (non-object region). A region having the absolute values exceeding the Th1 and less than Th2 is taken as indistinct region. And, a region having the absolute values exceeding Th2 is decided as the foreground (object region).

It may be assumed that the indistinct region coincides with both of the non-object region and the object region when to make the inside/outside judgment.

Also in the case where the template is the three-level bitmap, similarly, it may be assumed that the indistinct region always coincides with both regions when to make the inside/outside judgment.

(6-2) Other Methods for Obtaining Three-Level Bitmap

The calculation method of the three-level bitmap is not limited to this.

For example, when one or some of typical colors of an object and typical colors of a background are known, the calculation for generating the three-level bitmap may be made as follows. With respect to labels obtained by region splitting such as a WaterSheds method (L. Vincent, P. Soille, “Watersheds in Digital Spaces: An Efficient Algorithm Based on Immersion Simulations”, IEEE Trans. Pattern Anal. Machine Intell. vol. 13, no. 6, 1991), portions having colors close to the typical color of the object and portions having colors close to the typical color of the background are searched. Then, each of those searched-out regions is given with information designating either of an object region and a non-object region while the remaining regions are designated as indistinct regions. For example, in a color space, the Euclidean distance between the average color in the each label and a known color or the typical color is same with or less than a predetermined value.

In the case where a judgment using a normal vector is made by the “extended C-table” disclosed by Kimura and Watanabe mentioned in section (3), the judgment may be made as follows: the presence/absence of the indistinct region is registered in the extended C-table; or a normal vector to the indistinct region is separately recorded; and the judgment is made to all normal vectors in respect of each of the contour candidate points. Plural normal vectors may exist for one contour candidate point.

(7) Generalization of Judgment Using Normal Vector

The cosine value of an angle formed by normal vectors is obtained by the inner product of two unit vectors.

In the aforementioned inside/outside coincidence judgment, for example, when the inner product is no less than a threshold, it is determined that in inside/outside relations for the contour candidate point and a corresponding contour point on the template coincide with each other. The inner product is defined as (x1·x2+y1·y2) with respect to two vectors of (x1, y1) and (x2, y2) in the two-dimensional space. In short, the inside/outside coincidence judgment may also be made on basis of the inner product of the normal vectors, instead of the angle formed by the normal vectors.

The inner product may be defined other than the above, as long as the axiom of the inner product is satisfied. For example, the inner product may be defined as k(x1·x2+y1·y2) with respect to two vectors of (x1, y1) and (x2, y2). Other than the inner product, there may also be adopted a kernel function (for example, Gaussian kernel, polynomial kernel, “tanh” kernel), which is used in a support vector machine as one of methods of pattern recognition.

(8) Effects of the Introduction of Inside/Outside Judgment

By the pattern detection method of this embodiment, erroneous detection is decreased as compared with the conventional pattern detection method.

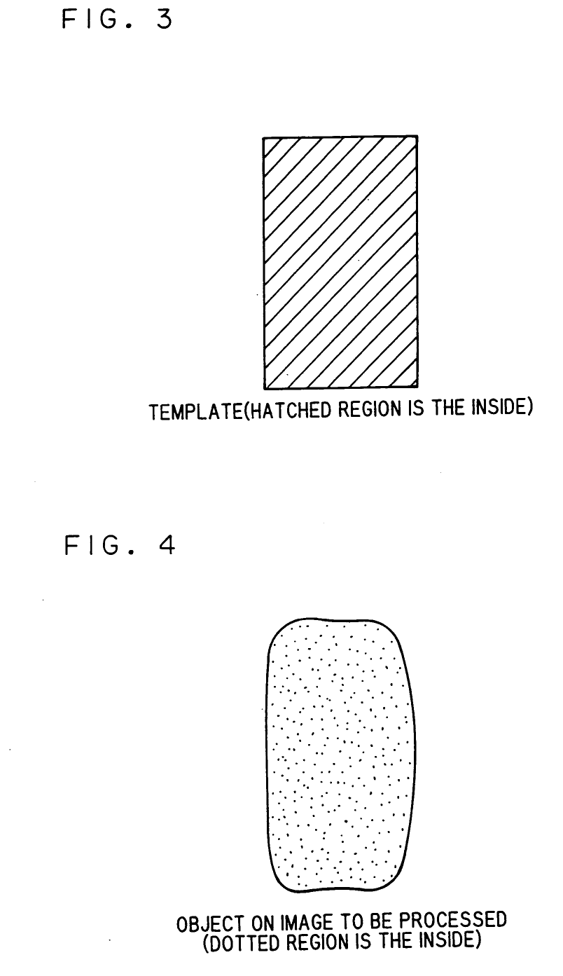

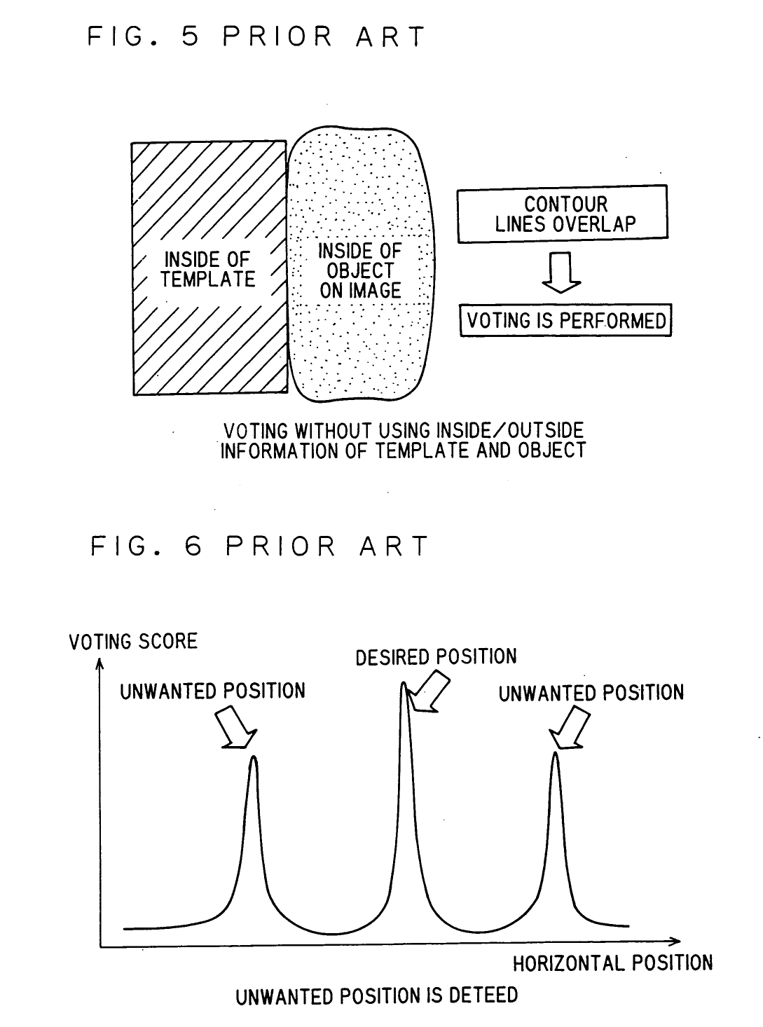

It is assumed here that pattern detection is performed in an image of FIG. 4 by using a template of FIG. 3. In the conventional generalized Hough transform, voting is performed also in the case of FIG. 5 in which the inside/outside relation is reversed from that of FIG. 4 while the contour line of the template overlaps with the contour candidate line of the object. Hence, distribution of the voting score becomes as shown in FIG. 6, and an unwanted position is erroneously detected.

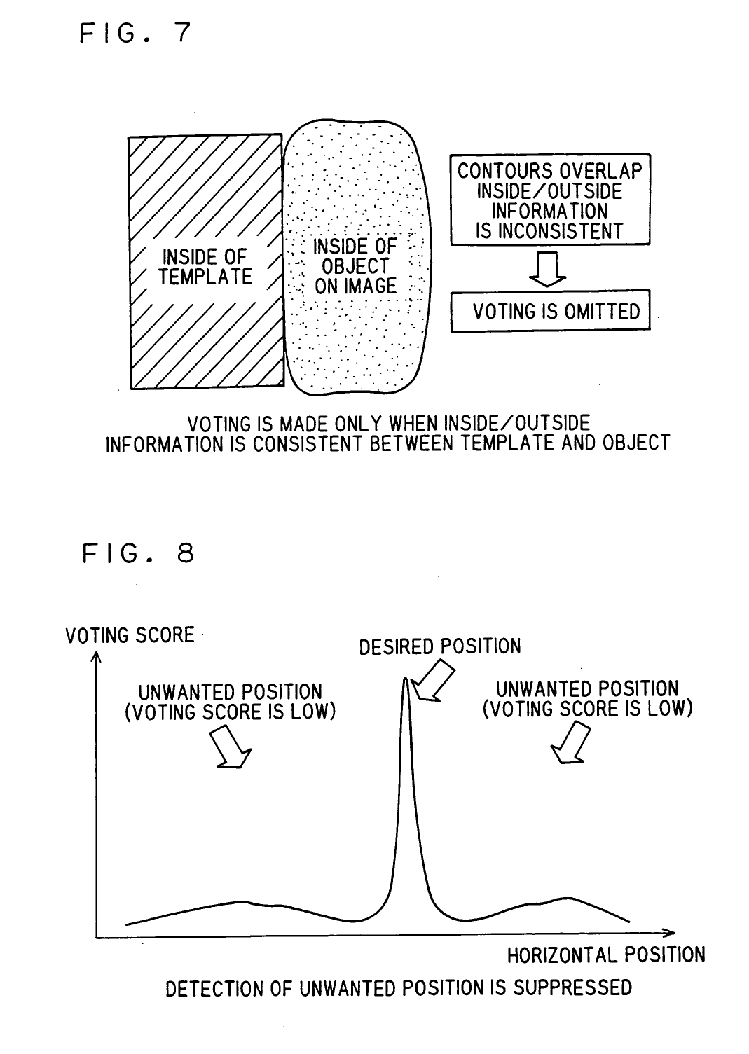

On contrary, in this embodiment, since voting is performed by taking account of the inside/outside relation, the voting is omitted at unwanted occasions such as the case of FIG. 7. As a result, the distribution of the voting score becomes as shown in FIG. 8, and erroneous detection of an unwanted position is suppressed.

### Second Embodiment

In a second embodiment, a weighting value is assigned to each contour point on the template.

In the foregoing first embodiment, in the case where the contour candidate point of the image overlaps with the contour point of the template, voting value of 1 is added to the histogram at each voting. However, irrespective of whether the two-level binary bitmap is introduced or not, the contour points of the template include; a point where it is highly probable that the contour candidate point of the object is identical to the contour point of the template when overlapping between the contour point and the contour candidate point occurs; and a point which has low reliability of identicalness even if the overlapping occurs.

In the conventional method, since voting value of 1 is always added without considering the reliability of the contour point, the detection may become difficult depending on the shape of the template.

For example, as shown in FIG. 9, in the case of the template having the shape of a flower bud, the look of a portion 901 near a “petal” is greatly varied depending on the position of a camera or the like; thus, the portion 901 near the “petal” is not much reliable.

In the second embodiment, the weighting value is newly assigned to the contour point of the template as will be described.

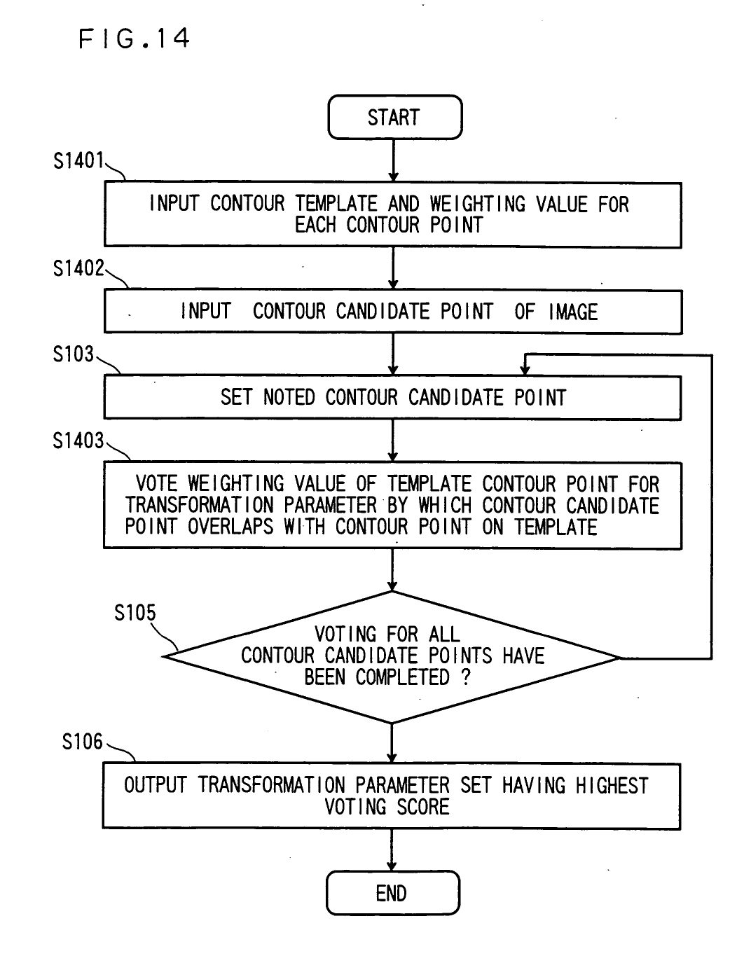

A flowchart of the method of this embodiment is as shown in FIG. 14.

Steps S1401, S1402 and S1403 are different from those of the flow of FIG. 1, while S1402 may be made in a manner as the conventional generalized Hough transform (GHT). That is, a contour point of an image obtained by edge detection or the like may be inputted.

Meanwhile, S1401 and S1403 are made, for example, as follows.

A template in which a weighting value of, for example, between 0 and 1 is set for each contour point thereof is inputted (S1401); and differently from the conventional method in which value of 1 is always added at the vote processing S104, the weighting value is voted as in S1403.

In otherwise, a value obtained by multiplying the weighting value of the contour point of the template by weighting value of the contour candidate point of the image described later or a value obtained by addition thereof may be voted.

By the above, the contribution ratio of the contour points having high reliability with respect to the judgment at S106 is improved, and thus, the detection rate is improved.

The value to be added at each voting may be obtained by performing any arithmetical operation on the weighting value of the contour point of the template, and is not limited to the weight value itself, or to a value obtained by multiplying the weighting value by some value or adding some value thereto. The value to be added may be any value as long as a function of the weighting value of the contour point.

### Third Embodiment

In a third embodiment, a weighting value is assigned to each contour candidate point on an image that is obtained by the edge detection or the like.

In the foregoing second embodiment, the weighting value is assigned to each of the contour points of the template. The same way of the assigning may be made to a contour candidate point of an image.

In the heretomentioned embodiments, the contour candidate point of the image is obtained by binarization after the edge detection, or is obtained based on the binary bitmap obtained by the difference method. In the edge detection, probability of being a contour is calculated; and in the difference method, probability of being an object region is calculated. When the value to be added is controlled or adjusted using such probability, the detection accuracy is improved. Hereinafter, the embodiment using such probability will be described.

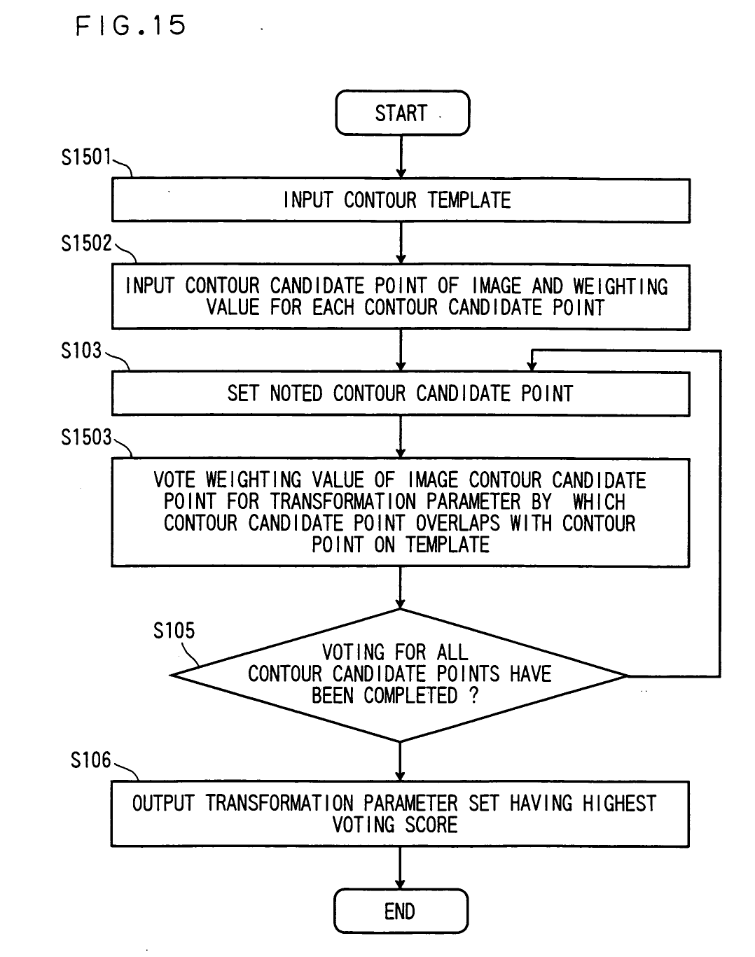

A flowchart of this embodiment is as shown in FIG. 15.

While the flowchart is similar to that of FIG. 14 explained before, it is different in that the contour candidate point of the image, not the template, has the weighting value. Steps S1501, S1502 and S1503 are different from those in the process flow of FIG. 1, and S1501 may be similar to the conventional GHT. That is, a contour point of a previously prepared template may be inputted. However, S1502 and S1503 are made as follows.

Each contour candidate point of an image and a weighting value of between 0 and 1 that is assigned to the each contour candidate point and has been obtained by the edge detection or the like are inputted (S1502). And differently from the conventional case where voting value of 1 is always added at each vote processing S104, this weighting value is voted as in S1503.

### Fourth Embodiment

In a fourth embodiment, a weighting value derived from a value obtained by the edge detection is used. In an example explained here, the probability of being an edge or contour point as obtained by the edge detection is used to find the weighting value for the each contour candidate point.

The probability of being the edge or contour point, or the weighted sum of the probability of the contour point and the probability of being the object region, is used as the weighting value of the contour candidate point of the image.

With respect to each contour candidate point of the image, a weighting value of between, for example, 0 and 255 is obtained.

At each vote processing S104, the weighting value of the contour candidate point of the image is voted.

In this way, the reliability of each contour candidate point is taken account for the judgment at S106, and thus, the detection rate is improved.

Similarly to the second embodiment, the value to be added in the each voting is not limited to the weighting value itself of the contour candidate point of the image or to a value obtained by multiplying the weighting value by some value or by adding some value to the weighting value. The value to be added may be any value as long as a function of the weighting value of the contour candidate point.

### Fifth Embodiment

In a fifth embodiment, certainty factor of the difference method is used. In an example explained here, the probability of being an edge or contour point as obtained by the difference method is used to find the weighting value for the each contour candidate point.

For example, in the case where the brightness is represented by 0 to 255, and the threshold of the difference method is “Th”, a region having the difference value within the range of 0 to “Th” is determined to be the background (non-object region); and a region having the difference value within the range of “Th” to 255 is determined to be the foreground (object region). Here, since the background is not voted, the weighting value is assigned only to points on the foreground. For example, the weighting value for the contour candidate point on the foreground may be found by following expression: “difference value”−“Th”. After the weighting value to each contour candidate point of the image is obtained, the processes same as the aforementioned embodiments of the edge detection may be used.

### Sixth Embodiment

In a sixth embodiment, a weighting value and an inner product are used.

In a process described in the foregoing section (7), inner-product of two normal vectors that are taken as unit vectors (length=1) is calculated. And then the inner product is used to obtain the cosine value of the angle of the two normal vectors, as to make the inside/outside coincidence judgment by comparing the angle with the threshold. Here, the inner product of the two normal vectors is used as a weighting factor that is further multiplied with the aforementioned-wise-obtained weighting value, so as such multiplied value to be added to the histogram at each voting.

The above process may be added as included with a processing that omits the addition of the value to the histogram or the voting when the inner product value is a threshold or less.

### Seventh Embodiment

In a seventh embodiment, both of the contour point and the contour candidate point are assigned with the weighting values, and the product of the two weighting values is used as the value to be added to the histogram at each voting.

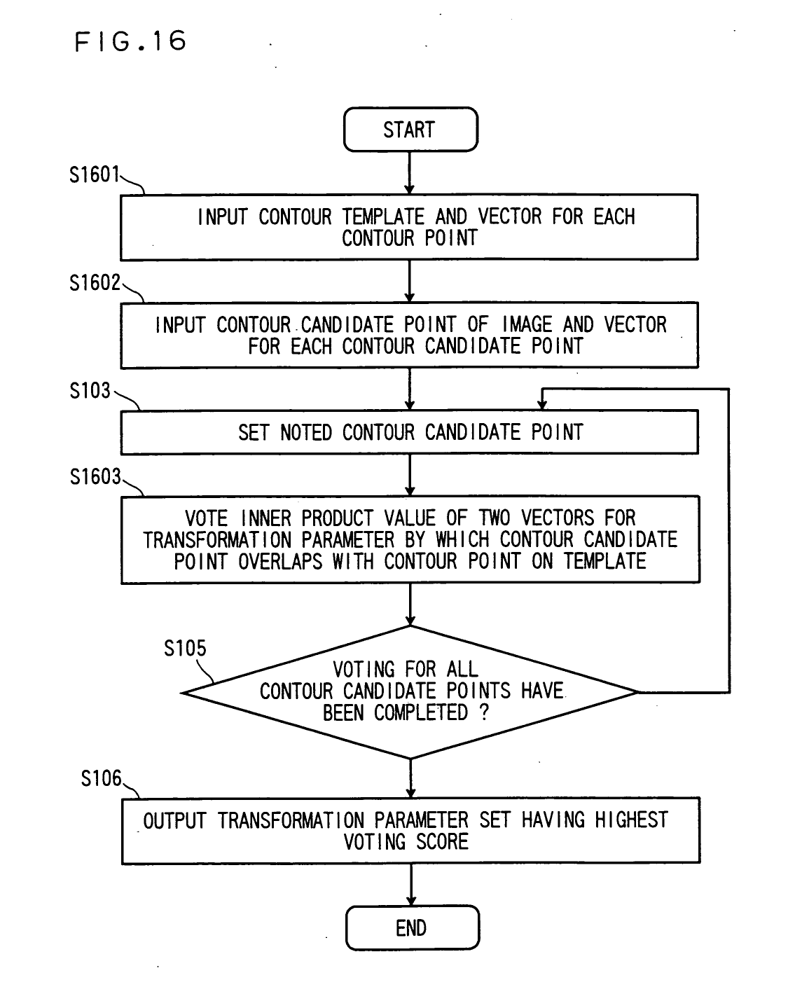

In this embodiment, with respect to each of the contour points of the template and the contour candidate points of the image, the length of the normal vector for the contour point and that for the contour candidate point are set to be: the weighting values for the contour point and the contour candidate point respectively, instead of the unit length (=1). And, the inner product of the two normal vectors is used as the value to be added to the histogram at each voting. The inner product is equal to the product of the weighting value of each contour candidate point and a weighting factor as the cosine value of the angle of the two normal vectors. FIG. 16 shows a flowchart of the embodiment using the inner product.

First, as indicated by S1601, on occasion of inputting a conventional template, a vector is also inputted for each contour candidate point. The normal vector is, for example, directed toward an object from the contour candidate point.

Next, as indicated by S1602, on occasion of inputting the contour candidate points of the image obtained by the edge detection to the image, a vector is also inputted for each contour candidate point. For example, similarly to the foregoing embodiments, the normal vector is inputted.

### Eighth Embodiment

The process flows of the flowcharts in FIGS. 14 to 16 are applicable irrespective of adopting or omitting the inside/outside judgment.

In the previous embodiment in regard to FIG. 16, it is explained an example in which the normal vector for the inside/outside judgment is used as the vector indicated in FIG. 16. Thus, it might appear that the inside/outside judgment is indispensable. However, the vector other than the normal vector, as long as the inner product of two arbitrary vectors, may be used.

In many cases, a vicinity region around the contour candidate point includes two color regions divided by the contour candidate line or a boundary of the object. For example, the difference value of the two colors is taken as the vector that is assigned to the contour candidate point, as to be used to find the inner product. When the color is consisting of three primary colors of red, green and blue (R, G, B), a three-dimensional vector is used, for example. In otherwise, a six-dimensional vector may be used by simply pairing two colors. When the absolute value of thus obtained inner product value is large, the correlation is regarded as being high. Thus, the absolute value of the inner product may be used, instead of the inner product itself, as to decide whether performing or omitting the voting.

A method of obtaining two typical colors when the vicinity of a noted point is not uniform, is disclosed, for example, by K. Haris et al. (“Hybrid Image Segmentation Using Watersheds and Fast Region Merging” IEEE Trans. Image Process., vol. 7, no. 12, dec, 1998).

In otherwise, the histogram of brightness is taken for pixels inside a predetermined radius “r” from a noted point; division into two parts is performed using the centroid or Fisher's linear discriminant standard; and the average color is obtained for each of the divided parts.

When, with respect to apart of the contour on the template, whole of the vicinity region around the contour candidate point belongs to the object region, both the two colors on both sides of the contour candidate line represent the color of the object region. In such occasion, taking account whether the difference values between the colors have a strong correlation contributes to the improvement of the detection rate. That is, in the color space, taking account whether the difference directions of respective pairs of color vectors in the color space are close to each other contributes to the improvement of the detection rate.

Same process as above may be performed using five-dimensional vectors, each of which has x/y components of the centripetal vector and R/G/B (primary colors) components of the difference of the color (RGB) vector.

[Modification]

The present invention is not limited to the above embodiments, but may be variously modified within the scope not departing from the gist.

What is claimed is:

1. A method for obtaining, by a computer, transformation parameters that facilitate transformation of a template as to be overlapped with an object in an image, comprising:
inputting a template having (1) contour points on a contour line of a pattern to be detected and (2) region distinguishing information to distinguish between an object region and a background region at each of the contour points;
inputting (1) contour candidate points on a contour candidate line of an object in the image and (2) region distinguishing information to distinguish between an object region and a background region for each of the contour candidate points;
transforming a position or a shape of the template by using each of transformation parameter set candidates;
obtaining an evaluation value on each overlapping pair between one of the contour candidate points in the image and one of the contour points of the template, which overlap with each other after the transformation using the each of the transformation parameter set candidates, the evaluation value being similarity of a distribution of the object and background regions between that based on the region distinguishing information of the template and that based on the region distinguishing information of the image;
obtaining a sum of the evaluation values only for those not smaller than a threshold evaluation value, for the each of the transformation parameter set candidates; and
outputting a transformation parameter set having largest sum of the evaluation values among the transformation parameter set candidates.

2. The method according to claim 1, wherein the region distinguishing information is a set of binary information to distinguish between the object region and the background region for each of the contour points or each of the contour candidate points.

3. The method according to claim 1, wherein the region distinguishing information is a set of ternary information to distinguish between the object region, the background region and an indistinct region for each of the contour points or each of the contour candidate points.

4. The method according to claim 1, wherein
the region distinguishing information for the each of contour points of the template includes a first vector being directed from the contour point toward the object, and
the region distinguishing information for the each of contour candidate points of the object includes a second vector being directed from the contour candidate point toward the object; and
further comprising
determining whether vector angle between the first and second vectors for the each of contour candidate points is within a predetermined vector angle range, and
omitting the obtaining evaluation value or discarding the evaluation value before the obtaining sum of the evaluation values when the vector angle is out of the predetermined vector angle range.

5. The method according to claim 4, wherein the determining in respect of the predetermined vector angle range is made by determining whether a kernel function of the first vector and the second vector or an inner product thereof is within a predetermined value range for the each of contour candidate points.

6. The method according to claim 4, wherein a kernel function of the first vector and the second vector or a value of an inner product thereof is used as the evaluation value when for the obtaining sum of the evaluation values.

7. The method according to claim 1, further comprising; assigning a weighting value to each of the contour points of the template and/or to each of the contour candidate points in the image, and thereby to each of the evaluation values; and wherein;
the obtaining sum of the evaluation values is made based on the weighting values respectively assigned to the evaluation values.

8. An apparatus for obtaining, by a computer, transformation parameters that facilitate transformation of a template as to be overlapped with an object, comprising:
a template input unit configured to input a template having (1) contour points on a contour line of a pattern to be detected and (2) region distinguishing information to distinguish between an object region and a background region at each of the contour points;
a candidate input unit configured to input (1) contour candidate points on a contour candidate line of the object in the image and (2) region distinguishing information to distinguish between an object region and a background region at each of the contour candidate points;
a transformation unit configured to transform a position or a shape of the template by using each of transformation parameter set candidates;
a calculation unit configured to obtain an evaluation value on each overlapping pair between one of the contour candidate points in the image and one of the contour points of the template, which overlap with each other after the transformation using the each of the transformation parameter set candidates, the evaluation value being similarity of a distribution of the object and background regions between that based on the region distinguishing information of the template and that based on the region distinguishing information of the image;
a vote unit configured to obtain a sum of the evaluation values only for those not smaller than a threshold evaluation value, for the each of the transformation parameter set candidates; and
a parameter output unit configured to output a transformation parameter set having largest sum of the evaluation values among the transformation parameter set candidates.

9. The apparatus according to claim 8, wherein the region distinguishing information is a set of binary information to distinguish between the object region and the background region for each of the contour points or each of the contour candidate points.

10. The apparatus according to claim 8, wherein the region distinguishing information is a set of ternary information to distinguish between the object region, the background region and an indistinct region for each of the contour points or each of the contour candidate points.

11. The apparatus according to claim 8, wherein
the region distinguishing information for the each of contour points of the template includes a first vector being directed from the contour point toward the object, and
the region distinguishing information for the each of contour candidate points of the object includes a second vector being directed from the contour candidate point toward the object; and
the vote unit determines whether vector angle between the first and second vectors for the each of contour candidate points is within a predetermined vector angle range, and includes the respective evaluation value into the sum only if the vector angle is within the predetermined vector angle range.

12. The apparatus according to claim 11, wherein the vote unit determines whether a kernel function of the first vector and the second vector or an inner product thereof is within a predetermined value range for the each of contour candidate points when to determine whether the vector angle is within the predetermined vector angle range.

13. The apparatus according to claim 11, wherein the vote unit uses, as the evaluation value, a kernel function of the first vector and the second vector or an inner product thereof.

14. The apparatus according to claim 8, wherein
a weighting value is assigned to each of the contour points of the template and/or to each of the contour candidate points in the image, and thereby to each of the evaluation values; and
the vote unit obtains the sum of the evaluation values based on the weighting values respectively assigned to the evaluation values.

15. A program product for obtaining, by a computer, transformation parameters that facilitate transformation of a template as to be overlapped with an object in an image, the program product comprising instructions of:
inputting a template having (1) contour points on a contour line of a pattern to be detected and (2) region distinguishing information to distinguish between an object region and a background region at each of the contour points;
inputting (1) contour candidate points on a contour candidate line of an object in the image and (2) region distinguishing information to distinguish between an object region and a background region for each of the contour candidate points;
transforming a position or a shape of the template by using each of transformation parameter set candidates;
obtaining an evaluation value on each overlapping pair between one of the contour candidate points in the image and one of the contour points of the template, which overlap with each other after the transformation using the each of the transformation parameter set candidates, the evaluation value being similarity of a distribution of the object and background regions between that based on the region distinguishing information of the template and that based on the region distinguishing information of the image;
obtaining a sum of the evaluation values only for those not smaller than a threshold evaluation value, for the each of the transformation parameter set candidates; and
outputting a transformation parameter set having largest sum of the evaluation values among the transformation parameter set candidates.

16. The program product according to claim 15, wherein the region distinguishing information is a set of binary information to distinguish between the object region and the background region for each of the contour points or each of the contour candidate points.

17. The program product according to claim 15, wherein the region distinguishing information is a set of ternary information to distinguish between the object region, the background region and an indistinct region for each of the contour points or each of the contour candidate points.

18. The program product according to claim 15, wherein
the region distinguishing information for the each of contour points of the template includes a first vector being directed from the contour point toward the object, and
the region distinguishing information for the each of contour candidate points of the object includes a second vector being directed from the contour candidate point toward the object; and
further comprising
determining whether vector angle between the first and second vectors for the each of contour candidate points is within a predetermined vector angle range, and
omitting the obtaining evaluation value or discarding the evaluation value before the obtaining sum of the evaluation values when the vector angle is out of the predetermined vector angle range.

19. The program product according to claim 18, wherein the determining in respect of the predetermined vector angle range is made by determining whether a kernel function of the first vector and the second vector or an inner product thereof is within a predetermined value range for the each of contour candidate points.

20. The program product according to claim 18, wherein a kernel function of the first vector and the second vector or a value of an inner product thereof is used as the evaluation value when for the obtaining sum of the evaluation values.

21. The program product according to claim 15, further comprising; assigning a weighting value to each of the contour points of the template and/or to each of the contour candidate points in the image, and thereby to each of the evaluation values; and wherein;
the obtaining sum of the evaluation values is made based on the weighting values respectively assigned to the evaluation values.
